(19) United States
(12) Patent Application Publication
(10) Pub. No.: US 2025/0380224 A1
(43) Pub. Date: Dec. 11, 2025

(54) RESOURCE BLOCK RESTRICTIONS

(71) Applicant: Apple Inc., Cupertino, CA (US)

(72) Inventors: Daniel Popp, Munich (DE); Anatoliy S. loffe, Sunnyvale, CA (US); Elmar Wagner, Taufkirchen (DE)

(73) Assignee: Apple Inc., Cupertino, CA (US)

(21) Appl. No.: 18/735,115

(22) Filed: Jun. 5, 2024

(51) Int. Cl. H04W 52/36; H04L 5/14; H04W 52/42

(52) U.S. Cl. CPC H04W 52/367; H04L 5/14; H04W 52/42

(57) ABSTRACT

The present application relates to devices and components including apparatus, systems, and methods for restricting resource blocks used by a user equipment (UE) for uplink transmission within a frequency band. In an example, the UE is a power class three (PC3) UE that implements a full-band duplexer. The UE can signal to a network whether the UE can meet emission requirements of the frequency band with or without using a resource block restriction. Subsequent to this signaling, the network can allocate resource blocks within the frequency band to the UE.

### BACKGROUND

Cellular communications can be defined in various standards to enable communications between a user equipment and a cellular network. For example, Fifth Generation mobile network (5G) is a wireless standard that aims to improve upon data transmission speed, reliability, availability, and more.

### BRIEF DESCRIPTION OF THE DRAWINGS

FIG. 1 illustrates an example of a network environment, in accordance with some embodiments.

FIG. 2 illustrates an example of uplink transmissions using a dual-duplexer user equipment (UE), in accordance with some embodiments.

FIG. 3 illustrates an example of uplink transmissions using a full-band duplexer UE, in accordance with some embodiments.

FIG. 4 illustrates another example of uplink transmissions using a full-band duplexer UE, in accordance with some embodiments.

FIG. 5 illustrates examples of resource block restrictions, in accordance with some embodiments.

FIG. 6 illustrates an example of a sequence diagram for resource block restrictions with modified maximum power reduction behavior, in accordance with some embodiments.

FIG. 7 illustrates an example of an operational flow/algorithmic structure related to resource block restrictions, in accordance with some embodiments.

FIG. 8 illustrates another example of an operational flow/algorithmic structure related to resource block restrictions, in accordance with some embodiments.

FIG. 9 illustrates an example of receive components, in accordance with some embodiments.

FIG. 10 illustrates an example of a UE, in accordance with some embodiments.

FIG. 11 illustrates an example of a base station, in accordance with some embodiments.

### DETAILED DESCRIPTION

Embodiments of the present disclosure are directed to, among other things, resource block restrictions. Generally, a user equipment (UE) can be associated with a power class indicating a maximum output power a transmission bandwidth within a channel of a frequency band. The UE may be allowed to reduce the maximum output power due to a number of factors (e.g., higher order modulations and/or transmit bandwidth configurations). For certain power classes, such as power class two (PC2) and power class three (PC3), the allowed maximum power reduction (MPR) can be predefined in a technical specification with which the UE complies. 3GPP Technical Specification (TS) 38.101-1, V18.5.0 (2024-03) is an example of the technical specification and is incorporated herein by reference in its entirety. For particular frequency bands of a network with which the UE communicates, the network can signal emission requirements that the UE needs to meet. To meet such emission requirements, additional maximum power reduction (A-MPR) can be allowed. The technical specification can also define the emission requirements with their associated network signaling (NS) values and the allowed A-MPR and applicable operating band(s) for each NS value.

In an example, a frequency band of the network may be adjacent to a protected frequency band (e.g., that of another network or used for services other than cellular communications). An in-band emission requirement can be defined for the frequency band such that to reduce or minimize leakage from uplink transmission in the frequency band into the protected frequency band. However, the UE can implement a full-band duplexer. In such an implementation, filter suppression may not be available. Accordingly, meeting the in-band emission requirement can become challenging. Furthermore, deployment of the network can assume that no A-MPR is to be used (e.g., only a 0 dB A-MPR is possible). As such, to meet the in-band emission requirement, a non-A-MPR solution is needed.

As further described herein, embodiments of the present disclosure provide such a solution, whereby a resource block restriction can be used. In particular, the network can signal to the UE one or more emission requirements for the frequency band (e.g., via an NS value). The UE can signal back whether one or more resource block restrictions are needed to meet the emission requirement(s) for the frequency band. In an example, modified MPR behavior information of the UE can include such signaling. Thereafter, the network can schedule an uplink transmission in resource blocks of a channel of the frequency band. These resource blocks may be configured according to a resource block restriction.

To illustrate, consider the use case of band number twenty-eight (n28). This frequency band can be adjacent to a protected frequency band in certain countries (e.g., in Japan and China, to name a few countries). The network can send an NS value (NS_X), where the technical specification can pre-associate this NS value with n28 and emission requirements. The UE can respond with signaling indicating whether a resource block restriction is needed to meet the emission requirements pre-associated with the NS value. For example, the signaling can include a radio frequency (RF) parameters information element (IE), such as an RF-parameters IE, having a modified MPR behavior (modifiedMPR-Behavior) field. A bit in the field can be set to a value that the technical specification pre-associates with whether the resource block restriction is needed or not. For example, a “0” value indicates that the emission requirements are met without the need for the resource block restriction. A “1” value indicates that the resource block restriction is indeed needed. As such, based on the value of this bit in the modifiedMPR-Behavior field, the network can determine whether the resource block restriction needs to be used for uplink transmissions of the UE using a channel within n28. The network configures resource block for the uplink transmissions, where these resource blocks may, but need not, be restricted (e.g., the network may decide whether the resource block restriction, if needed, is to be used or not).

Embodiments of the present disclosure provide several technical improvements. For example, the embodiments enable a UE to meet in-band emission requirements of a network without the need to use A-MPR.

Embodiments of the present disclosure are described in connection with 5G networks. However, the embodiments are not limited as such and similarly apply to other types of communication networks including other types of cellular networks. Further, the embodiments are described in connection with n28. However, the embodiments are not limited as such and similarly apply to other frequency bands that may be associated with particular emission requirements.

The following detailed description refers to the accompanying drawings. The same reference numbers may be used in different drawings to identify the same or similar elements. In the following description, for purposes of explanation and not limitation, specific details are set forth, such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrase “A or B” means (A), (B), or (A and B).

The following is a glossary of terms that may be used in this disclosure.

The term “circuitry” as used herein refers to, is part of, or includes hardware components, such as an electronic circuit, a logic circuit, a processor (shared, dedicated, or group) or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, or transferring digital data. The term “processor circuitry” may refer to an application processor, baseband processor, a central processing unit (CPU), a graphics processing unit, a single-core processor, a dual-core processor, a triple-core processor, a quad-core processor, or any other device capable of executing or otherwise operating computer-executable instructions, such as program code, software modules, or functional processes.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “base station” as used herein refers to a device with radio communication capabilities, that is a network component of a communications network (or, more briefly, a network), and that may be configured as an access node in the communications network. A UE's access to the communications network may be managed at least in part by the base station, whereby the UE connects with the base station to access the communications network. Depending on the radio access technology (RAT), the base station can be referred to as a gNodeB (gNB), eNodeB (eNB), access point, etc.

The term “network” as used herein reference to a communications network that includes a set of network nodes configured to provide communications functions to a plurality of user equipment via one or more base stations. For instance, the network can be a public land mobile network (PLMN) that implements one or more communication technologies including, for instance, 5G communications.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link” as used herein refers to a connection between two devices for the purpose of transmitting and receiving information.

The term “connected” may mean that two or more elements, at a common communication protocol layer, have an established signaling relationship with one another over a communication channel, link, interface, or reference point.

The term “information element” refers to a structural element containing one or more fields. The term “field” refers to individual contents of an information element, or a data element that contains content. An information element may include one or more additional information elements.

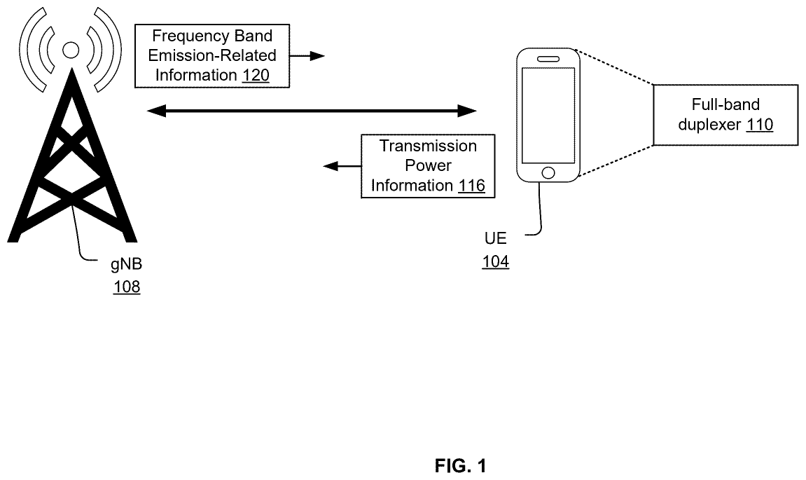

FIG. 1 illustrates a network environment 100, in accordance with some embodiments. The network environment 100 may include a UE 104 and a gNB 108. The gNB 108 may be a base station that provides a wireless access cell, for example, a Third Generation Partnership Project (3GPP) New Radio (NR) cell, through which the UE 104 may communicate with the gNB 108. The UE 104 and the gNB 108 may communicate over an air interface compatible with 3GPP technical specifications, such as those that define Fifth Generation (5G) NR system standards.

The gNB 108 may transmit information (for example, data and control signaling) in the downlink direction by mapping logical channels on the transport channels and transport channels onto physical channels. The logical channels may transfer data between a radio link control (RLC) and MAC layers; the transport channels may transfer data between the MAC and PHY layers; and the physical channels may transfer information across the air interface. The physical channels may include a physical broadcast channel (PBCH), a physical downlink control channel (PDCCH), and a physical downlink shared channel (PDSCH).

The PBCH may be used to broadcast system information that the UE 104 may use for initial access to a serving cell. The PBCH may be transmitted along with physical synchronization signals (PSS) and secondary synchronization signals (SSS) in a synchronization signal block (SSB). The SSBs may be used by the UE 104 during a cell search procedure (including cell selection and reselection) and for beam selection.

The PDSCH may be used to transfer end-user application data, signaling radio bearer (SRB) messages, system information messages (other than, for example, MIB), and SIs.

The PDCCH may transfer DCI that is used by a scheduler of the gNB 108 to allocate both uplink and downlink resources. The DCI may also be used to provide uplink power control commands, configure a slot format, or indicate that preemption has occurred.

The gNB 108 may also transmit various reference signals to the UE 104. The reference signals may include demodulation reference signals (DMRSs) for the PBCH, PDCCH, and PDSCH. The UE 104 may compare a received version of the DMRS with a known DMRS sequence that was transmitted to estimate an impact of the propagation channel. The UE 104 may then apply an inverse of the propagation channel during a demodulation process of a corresponding physical channel transmission.

The reference signals may also include CSI-RS. The CSI-RS may be a multi-purpose downlink transmission that may be used for CSI reporting, beam management, connected mode mobility, radio link failure detection, beam failure detection and recovery, and fine-tuning of time and frequency synchronization.

The reference signals and information from the physical channels may be mapped to resources of a resource grid. There is one resource grid for a given antenna port, subcarrier spacing configuration, and transmission direction (for example, downlink or uplink). The basic unit of an NR downlink resource grid may be a resource element, which may be defined by one subcarrier in the frequency domain and one orthogonal frequency division multiplexing (OFDM) symbol in the time domain. Twelve consecutive subcarriers in the frequency domain may compose a physical resource block (PRB). A resource element group (REG) may include one PRB in the frequency domain, and one OFDM symbol in the time domain, for example, twelve resource elements. A control channel element (CCE) may represent a group of resources used to transmit PDCCH. One CCE may be mapped to a number of REGs (for example, six REGs).

The UE 104 may transmit data and control information to the gNB 108 using physical uplink channels. Different types of physical uplink channels are possible including, for instance, a physical uplink control channel (PUCCH) and a physical uplink shared channel (PUSCH). Whereas the PUCCH carries control information from the UE 104 to the gNB 108, such as uplink control information (UCI), the PUSCH carries data traffic (e.g., end-user application data), and can carry UCI.

The UE 104 and the gNB 108 may perform beam management operations to identify and maintain desired beams for transmission in the uplink and downlink directions. The beam management may be applied to both PDSCH and PDCCH in the downlink direction, and PUSCH and PUCCH in the uplink direction.

In an example, communications with the gNB 108 and/or the base station can use channels in the frequency range 1 (FR1), frequency range 2 (FR2), and/or a higher frequency range (FRH). The FR1 band includes a licensed band and an unlicensed band. The NR unlicensed band (NR-U) includes a frequency spectrum that is shared with other types of radio access technologies (RATs) (e.g., LTE-LAA, WiFi, etc.). A listen-before-talk (LBT) procedure can be used to avoid or minimize collision between the different RATs in the NR-U, whereby a device should apply a clear channel assessment (CCA) check before using the channel.

In an example, the communications between the gNB 108 and the UE 104 relies on a frequency band that is adjacent to a protected frequency band. The communications may need to meet in-band emission requirements defined for the frequency band such that interference with the protected frequency band is reduced, minimized, or even eliminated. An example of the frequency band is n28. The gNB 108 can send frequency-band emission-related information 120 to the UE 104. For instance, the frequency-band emission-related information 120 can include an NS value (NS_X). This value can be pre-associated with emission requirements that the UE 104 needs to meet when communicating with (e.g., for its uplink transmissions to) gNB 108. The UE 104 can implement a full-band duplexer 110 for its communications (e.g., for at least its uplink transmissions that use the frequency band). The UE 104 can send transmission power information 116 to the gNB 108. The transmission power information 116 can indicate whether restrictions on the allocation of resource blocks within the frequency band are needed to meet the emission requirements. For instance, this indication can be included in an modifiedMPR-Behavior field of an RF-parameters IE. The gNB 108 may, but need not, allocate resource blocks within a channel of the frequency band according to a resource block restriction. The UE 104 can then use the allocated resource blocks for its uplink transmissions.

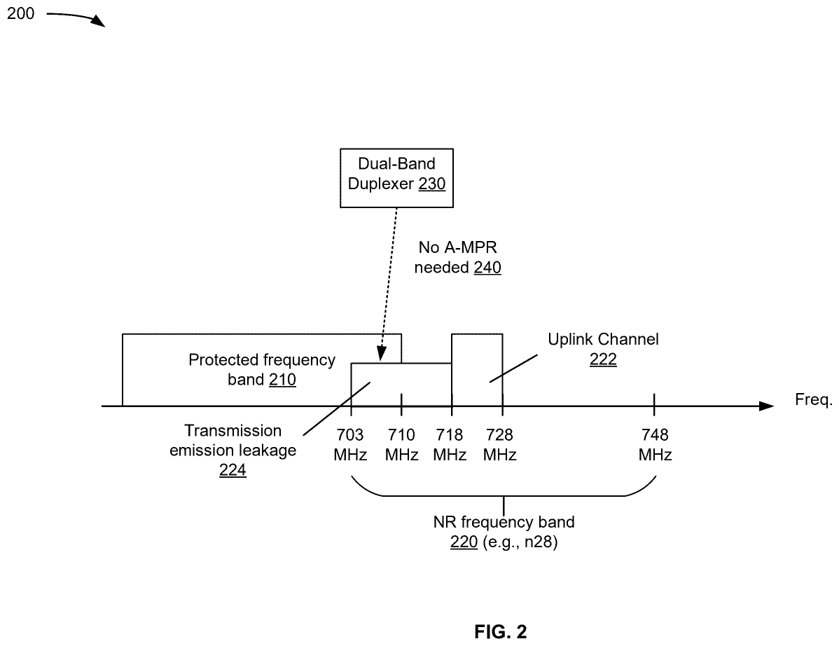

FIG. 2 illustrates an example 200 of uplink transmissions using a dual-duplexer UE, in accordance with some embodiments. The dual-duplexer UE is an example of the UE 104. As illustrated, resource blocks of an uplink channel 222 (e.g., a 10 MHz channel, or some other channel bandwidth) within an NR frequency band (e.g., n28) are allocated to the dual-duplexer UE for the uplink transmissions. The NR frequency band is available from a network (e.g., a base station such as the gNB 108) and is adjacent to a protected frequency band 210.

The dual-duplexer UE allows bi-directional communications over the NR frequency band 220. In the example 200, the dual-duplexer functionality is illustrated as a dual-band duplexer 230 that enables the UE (e.g., its RF front end and related circuitry) to divide the NR frequency band 220 into a lower and upper region and support frequency division duplexing (FDD). The lower region can include frequencies between 703 MHz and 748 MHz and be used for uplink. The upper region of the NR frequency band 220 is not explicitly illustrated in FIG. 2 but includes additional frequencies for downlink (e.g., in the case of n28, these frequencies are between 758 MHz and 803 MHz).

The dual-band duplexer 230 can provide filter suppression (e.g., in the form of a band-pass filter or a high-pass filter). The uplink channel 222 can be placed with its lower edge at or close to the lower edge of the NR frequency band (e.g. at or close to 718 MHz, whereby the starting resource block usable for the uplink transmissions has a frequency carrier at or close to 718 MHz). In this case, the uplink channel 222 can have strong emissions falling into the protected frequency band 710 (e.g., the 718 MHz can be the F_{OOB}—the boundary between the NR out of band emission and spurious emission domains). In the case of the protected frequency band 710 being between 470 MHz and 710 MHz, such emissions can be characterized as −26.2 dBm/6 MHz and is shown in FIG. 2 as a transmission emission leakage 224 (and can also be referred to as in-band emissions). The filter suppression can reduce, minimize, or eliminate the transmission emission leakage 224 such that any in-band emission requirements can be met without the need for A-MPR 240.

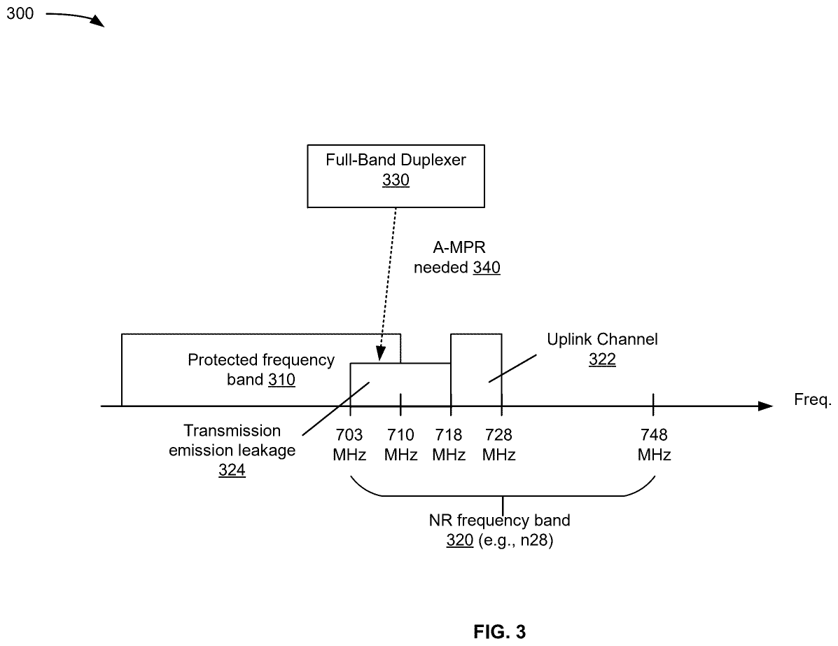

FIG. 3 illustrates an example 300 of uplink transmissions using a full-band duplexer UE, in accordance with some embodiments. The full-band duplexer UE is an example of the UE 104. As illustrated, resource blocks of an uplink channel 322 (e.g., a 10 MHz channel, or some other channel bandwidth) within an NR frequency band (e.g., n28) are allocated to the full-band duplexer UE for the uplink transmissions. The NR frequency band is available from a network (e.g., a base station such as the gNB 108) and is adjacent to a protected frequency band 310.

The full-band duplexer UE allows bi-directional communications over the NR frequency band 320. In the example 300, the full-band duplexer functionality is illustrated as a full-band duplexer 330. The full-band duplexer 330 can cover the whole NR frequency band 320 and may not provide any filter suppression for the in-band emission requirements.

The uplink channel 322 can be placed with its lower edge at or close to the lower edge of the NR frequency band (e.g. at or close to 718 MHz, whereby the starting resource block usable for the uplink transmissions has a frequency carrier at or close to 718 MHz). In this case, because full-band duplexer 330 may not provide filter suppression, transmission emission leakage 324 (e.g., in-band emission from the uplink channel 322 into the protected frequency band 310) may not be reduced, minimized, or eliminated through filtering. Instead, A-MPR may be needed 340 to meet the in-band emission requirement. Particularly, for a PC2 or PC3 full-band duplexer UE, A-MPR can be reduced to further reduce the uplink transmit power such that the in-band emission is met. However, the use of A-MPR for particular UE power classes (e.g., PC3) may not be preferred because such a use can introduce uplink degradation (e.g., network coverage holes), which can impact the already deployed networks. As such, the use of A-MPR for full-band duplexer, although possible, may not be optimal with certain UE power classes.

Deployments for band n28 and PC3 exist or are planned in certain geographical regions (e.g., Japan and China). Such deployments can be made under the assumption of 0 dB A-MPR (e.g., A-MPR is not used). In comparison, the full-band duplexer 330 may be implemented and can support the band n28. The full-band duplexer 330 may not provide filter support for the in-band emission requirements. Without filter suppression against the in-band emission requirements from dual-duplexer solution, there is a need for A-MPR. Because the deployment assumes A-MPR is not used and because the solution of example 300 relies on the use of A-MPR, this solution may not be optimal for the deployment (e.g., a tradeoff can be made, where the deployment allows the use of A-MPR, resulting in network coverage holes).

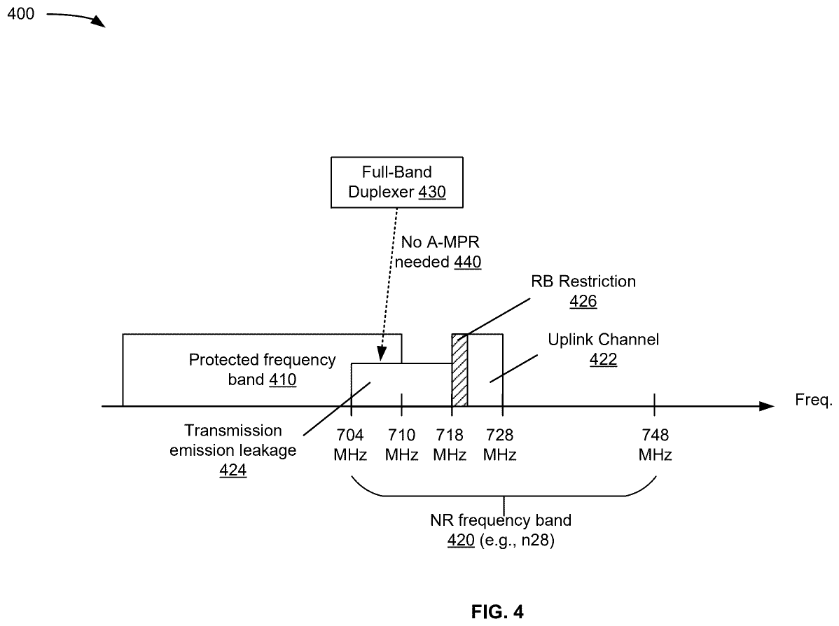

FIG. 4 illustrates another example 400 of uplink transmissions using a full-band duplexer UE, in accordance with some embodiments. Relative to example 300, here a solution is provided to avoid additional power back-off (e.g., A-MPR) while enabling the use of a full-band duplexer 430. In other words, the solution of example 400 may be more optimal than that of example 300 because the impact to the network can be relatively lessened.

Referring to the specifics of example 400, the full-band duplexer UE is an example of the UE 104. As illustrated, resource blocks of an uplink channel 422 (e.g., a 10 MHz channel, or some other channel bandwidth) within an NR frequency band (e.g., n28) are allocated to the full-band duplexer UE for the uplink transmissions. The NR frequency band is available from a network (e.g., a base station such as the gNB 108) and is adjacent to a protected frequency band 410.

The full-band duplexer UE allows bi-directional communications over the NR frequency band 420. In the example 400, the full-band duplexer functionality is illustrated as the full-band duplexer 430. The full-band duplexer 430 can cover the whole NR frequency band 420 and may not provide any filter suppression for the in-band emission requirements.

The uplink channel 422 can be placed with its lower edge at or close to the lower edge of the NR frequency band (e.g. at or close to 718 MHz, whereby the starting resource block usable for the uplink transmissions has a frequency carrier at or close to 718 MHz). In this case, because full-band duplexer 430 may not provide filter suppression, transmission emission leakage 424 (e.g., in-band emission from the uplink channel 422 into the protected frequency band 410) may not be reduced, minimized, or eliminated through filtering. Instead, a resource block (RB) restriction 426 can be used, thereby avoiding the need for A-MPR 440.

The RB restriction 426 can define a frequency region within the uplink channel 422 that cannot be allocated to the UE or used by the UE for uplink transmissions, whereby a remaining frequency region of the uplink channel 422 can be allocated to the UE or used by the UE for uplink transmission. Conversely, the RB restriction 426 can define a frequency region within the uplink channel 422 that can be allocated to the UE or used by the UE for uplink transmissions, whereby a remaining frequency region of the uplink channel 422 cannot be allocated to the UE or used by the UE for uplink transmission. Generally, the un-allocatable or unusable frequency region corresponds to a set of resource blocks (“N_{RB}”) that may be close to or at a lower edge of the uplink channel 422 (e.g., starting at F_{OOB}).

In an example, the RB restriction 426 is used for a PC2 or PC3 full-band duplexer UE, without the need to use A-MPR for the frequency band n28. For other power class UEs, other duplexer types, and/or other frequency bands, the the RB restriction 426 may not be used (but it is possible to use it as well).

Because the RB restriction 426 enables the use of a PC2 or PC3 full-band duplexer UE without the need for A-MPR, the impact to the network is lessened. Particularly, no network coverage holes (or a lower number of such holes) becomes possible while still meeting the in-band emission requirements.

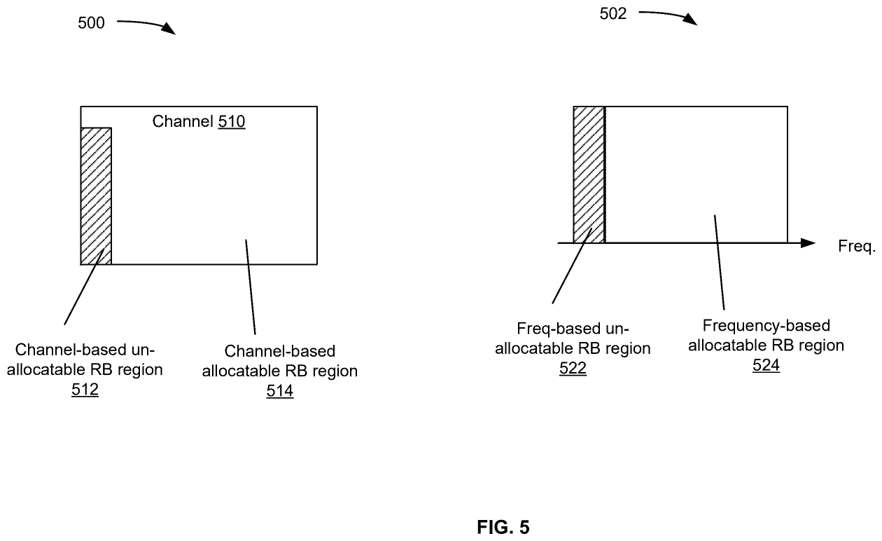

FIG. 5 illustrates examples of resource block restrictions, in accordance with some embodiments. Generally, a resource block restriction can be a restriction out and/or a restriction in. A restriction out corresponds to a set of resource blocks that cannot be allocated to a UE or, if allocated, cannot be used by the UE. When the set includes more than one resource block, the resource blocks of the set can be contiguous in the frequency domain. A restriction in corresponds to a set of resource blocks that can be allocated to and used by the UE. In this case, the remaining resource blocks cannot be allocated to the UE or, if allocated, cannot be used by the UE and can be contiguous in the frequency domain. In both cases, a frequency band can be associated with one or more resource block restrictions. At least one resource block restriction can be associated with at least one channel within the frequency band. For instance, at least a 10 MHz channel (or some other bandwidth channel) starting at a lower edge of the frequency band (e.g., at the F_{OOB}) can be associated with at least one resource block restriction. The restricted resource block(s) of the restriction block restriction can form a frequency region (referred to as possible a “restricted frequency region” or a “restricted region” within a channel and/or a frequency band). The frequency region can include one or more resource blocks starting at the lower edge of the channel (e.g., at the F_{OOB}).

Different techniques are possible to define a restricted region of a resource block restriction. FIG. 5 illustrates two of such techniques. In a first example technique 500, the restriction region is defined relative to a channel 510. For instance, the definition can use a channel raster associated with the channel 510. Generally, a channel raster defines a subset of RF reference frequencies that can be used to identify the RF channel position in the uplink and downlink. As such, the restriction region can be defined by referencing a particular channel raster. In this example technique 500, and for a restriction out, the frequency region can indicate a channel-based un-allocatable resource block region 512 (e.g., a set of resource blocks that are within the channel 510 and that cannot be allocated). Also in this example technique 500, and for a restriction in, the frequency region can indicate a channel-based allocatable resource block region 514 (e.g., a set of resource blocks that are within the channel 510 and that can be allocated).

In a second example technique 502, the restriction region is defined relative to a frequency (or a set of frequencies). For instance, the definition can reference a set of sub-carrier frequencies corresponding to resource blocks. In this example technique 502, and for a restriction out, the frequency region can indicate a frequency-based un-allocatable resource block region 522 (e.g., a set of subcarrier frequencies that are within the frequency band and that cannot be allocated). Also in this example technique 502, and for a restriction in, the frequency region can indicate a frequency-based allocatable resource block region 524 (e.g., a set of frequencies that are within the frequency band and that can be allocated).

In both above example, different techniques can exist to define the size and/or frequency position of the frequency region (e.g., the number of restricted resource blocks “restricted N_{RB}”). For example, RF testing can be performed under different conditions and using different sizes and/or frequency positions (and possibly power classes) to measure the resulting in-band emissions. The size(s) and/or frequency position(s) that meet the in-band emission requirements can be stored. A particular size and frequency position can be associated with a resource block restriction. As such, a network can pre-define resource block restriction(s) for the frequency band and/or a channel within the frequency band (and, possibly UE power class). Each of such resource block restrictions can indicate allocatable resource blocks (in the case of a restriction in) or un-allocatable resource blocks (in the case of a restriction out).

Furthermore, the size of a frequency region of a resource block restriction can be dynamically adjusted. For instance, a first set of contiguous resource blocks can be restricted out at a first time. Upon a change to network conditions (e.g., increase to or decrease of in-band emissions), a second set of resource blocks can be restricted out. If the network conditions worsen (e.g., increase to in-band emissions), the second set can be larger than the first set. Conversely, if the network conditions improve (e.g., decrease of in-band emissions), the second set can be smaller than the first set.

The network need not signal a frequency region of a resource block restriction to the UE. Instead, the network may allocate resource blocks to the UE depending on the frequency region (e.g., such that the UE is configured with only usable resource blocks). However, it may be possible that the network signals the frequency region to the UE (e.g., by referencing a channel raster or a subcarrier frequency and a size of the frequency region). In this case, the network may allocate unusable and usable resource blocks to the UE. In turn, based on the signaling of the frequency region, the UE may determine the usable resource blocks among the allocated resource blocks.

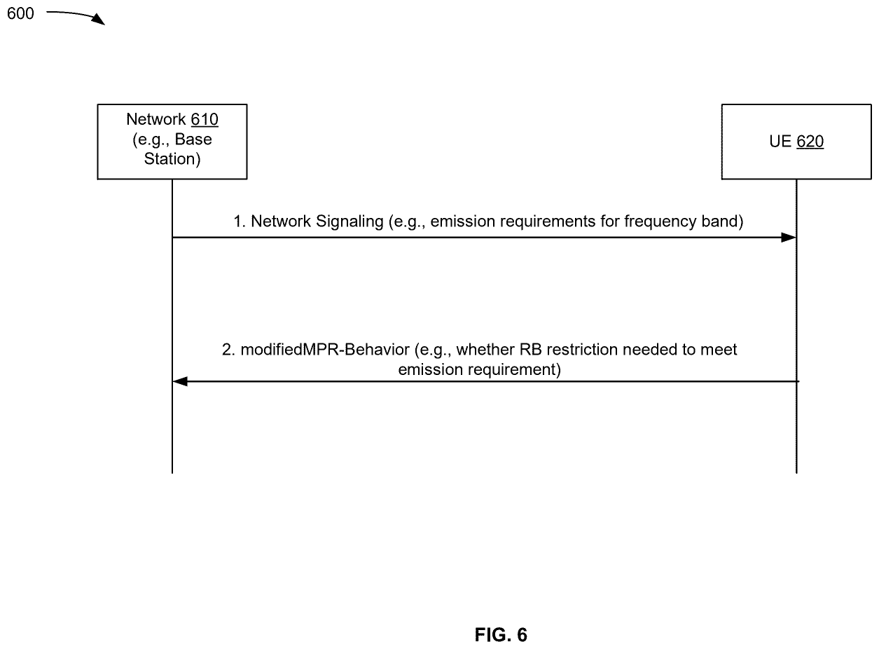

FIG. 6 illustrates an example 600 of a sequence diagram for resource block restrictions with modified maximum power reduction behavior, in accordance with some embodiments. The sequence diagram involves a network 610 (e.g., a base station thereof, such as the gNB 108) and a UE 620 (e.g., such as the UE 104).

As illustrated, the sequence diagram 600 includes the network 610 sending network signaling (NS) about emission requirements for a frequency band. For example, emission limits can be signaled via a dedicated network signaling flag (e.g., an NS value). This flag can be pre-associated with the frequency band and the emission limits in a technical specification with which the UE 620 complies, such as 3GPP TS 3GPP Technical Specification (TS) 38.101-1. The network signaling flag is indicated by the network 610 via radio resource control (RRC) or other configuration commands (e.g., DCI, media access control (MAC) control element (CE)). The UE 620 receives the network signaling and determines and applies the corresponding requirements.

It may be possible that the UE's 620 behavior deviates from an expected behavior to meet the emission requirements. In that case, the UE 620 can signal deviating behavior by setting certain bits in a bitmap field. For example, the bitmap field can be a field within modifiedMPR-Behavior of an RF-parameters IE. As illustrated in the sequence diagram, the UE 620 can signal the modifiedMPR-Behavior to the network 610. Generally, this bitmap field is typically used to indicate appliance of different MPR or A-MPR. However, here, the bitmap field can be re-purposed (or a new bitmap field can be defined) to indicate whether a resource block restriction is needed to meet the emission requirements for the frequency band. For example, a single bit can be used. A value of “0” can indicate that no modified behavior is needed for the frequency band (e.g., the emission requirements can be met without restricting resource blocks). A value of “1” can indicate that modified behavior is needed for the frequency band (e.g., the emission requirements can be met only if resource blocks are restricted). The UE 620 need not indicate the frequency region of the resource block restriction (e.g., the UE 620 may only need that resource blocks need to be restricted). However, it may be possible that the UE 620 indicates the specific frequency region (e.g., by using additional bits of the bitmap field, where the values of the additional bits are pre-associated in the technical specification with possible frequency regions).

As such, the sequency diagram involves the UE 620 to the network 610 whether any resource block restriction is to be used in order to meet the emission requirements of the frequency band. A resource block restriction can prohibit the use of resource blocks allocations which have more power back-off need than MPR allows. In a way, the resource block restriction can be considered to modify the UE's 620 behavior together with a modifiedMPR-Behavior bitmap field.

The network 610 can (but need not) apply the resource block restriction (e.g., by allocating the relevant resource blocks for the UE 620 to use in uplink transmissions). If the network 610 applies the resource block restriction, the resource blocks allocated to the UE 620 are restricted within the frequency band to the ones that the UE 620 can use for the uplink transmissions, while meeting the emission requirements of the frequency band and without necessitating A-MPR. If the network 610 does not apply the resource block restriction, the resource blocks allocated to the UE 620 are unrestricted within the frequency band, whereby the UE 620 may not emission requirements of the frequency band unless A-MPR is used, or whereby the UE 620 is not allowed to use or is assumed not to use A-MPR and network coverage holes can be expected.

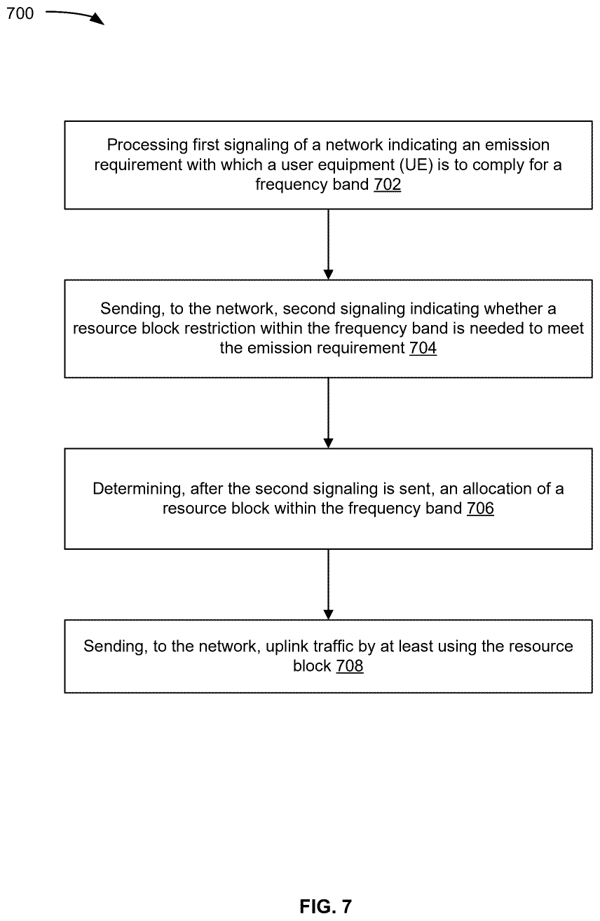

FIG. 7 illustrates an example of an operational flow/algorithmic structure 700 related to resource block restrictions, in accordance with some embodiments. The operational flow/algorithmic structure 700 can be implemented by a UE (e.g., performed by components thereof including, for example, an apparatus of the UE, where the apparatus includes processing circuitry). The UE can correspond to any of the UEs described herein and can include a full-band duplexer. In some embodiments, the operational flow/algorithmic structure 700 may be implemented by executing instructions stored in a tangible, non-transitory, computer-readable storage medium, such as a memory of the UE. While the operational flow/algorithmic structure 700 is described using steps in a specific sequence, it should be understood that the present disclosure contemplates that the described steps may be performed in different sequences than the sequence illustrated, and certain described steps may be omitted or not performed altogether.

In an example, the operational flow/algorithmic structure 700 includes, at 702, processing first signaling of a network indicating an emission requirement with which a user equipment (UE) is to comply for a frequency band. For instance, the first signaling is received from a base station of the network and is RRC signaling that indicates an NS value. The NS value can be pre-associated with the frequency band and the related emission requirement(s).

In an example, the operational flow/algorithmic structure 700 includes, at 704, sending, to the network, second signaling indicating whether a resource block restriction within the frequency band is needed to meet the emission requirement. For instance, the second signaling is RRC signaling (or another layer signaling, such as MAC CE or UCI) and can include a set of bits, the value of which indicates whether any resource block restriction is needed or not. In one particular example, the set of bits is a single bit within a modifiedMPR-Behavior bitmap field.

In an example, the operational flow/algorithmic structure 700 includes, at 706, determining, after the second signaling is sent, an allocation of a resource block within the frequency band. The resource block allocation can be received from the network (e.g., the base station) after the second signaling is sent. As explained herein above, the network can, but need not, apply a resource block restriction. The allocation can be part of a resource allocation signaled in an RRC configuration, MAC CE, or DCI (e.g., a frequency domain resource assignment (FDRA)).

In an example, the operational flow/algorithmic structure 700 includes, at 708, sending, to the network, uplink traffic by at least using the resource block. For instance, upon an uplink grant (e.g., via DCI), the UE uses the resource blocks to transmit data to the network (e.g., following modulation, layer mapping, precoding, RF mapping, etc.).

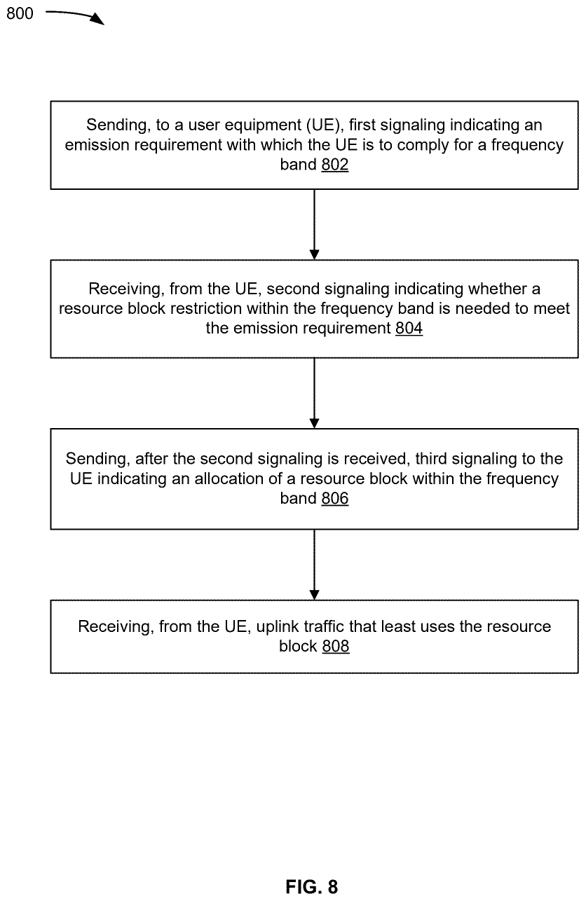

FIG. 8 illustrates another example of an operational flow/algorithmic structure 800 related to resource block restrictions, in accordance with some embodiments. The operational flow/algorithmic structure 800 can be implemented by a network (e.g., by a base station thereof and/or an apparatus of the base station, where the apparatus includes processing circuitry). The network can be any of the networks described herein. In some embodiments, the operational flow/algorithmic structure 800 may be implemented by executing instructions stored in a tangible, non-transitory, computer-readable storage medium, such as a memory of the base station. While the operational flow/algorithmic structure 800 is described using steps in a specific sequence, it should be understood that the present disclosure contemplates that the described steps may be performed in different sequences than the sequence illustrated, and certain described steps may be omitted or not performed altogether.

In an example, the operational flow/algorithmic structure 800 includes, at 802, sending, to a user equipment (UE), first signaling indicating an emission requirement with which the UE is to comply for a frequency band. For instance, the first signaling is sent by the base station and is RRC signaling that indicates an NS value. The NS value can be pre-associated with the frequency band and the related emission requirement(s).

In an example, the operational flow/algorithmic structure 800 includes, at 804, receiving, from the UE, second signaling indicating whether a resource block restriction within the frequency band is needed to meet the emission requirement. For instance, the second signaling is RRC signaling (or another layer signaling, such as MAC CE or UCI) and can include a set of bits, the value of which indicates whether any resource block restriction is needed or not. In one particular example, the set of bits is a single bit within a modifiedMPR-Behavior bitmap field.

In an example, the operational flow/algorithmic structure 800 includes, at 806, sending, after the second signaling is received, third signaling to the UE indicating an allocation of a resource block within the frequency band. As explained herein above, the network can, but need not, apply a resource block restriction. The allocation can be part of a resource allocation signaled in an RRC configuration, MAC CE, or DCI (e.g., a frequency domain resource assignment (FDRA)).

In an example, the operational flow/algorithmic structure 800 includes, at 808, receiving, from the UE, uplink traffic that least uses the resource block. For instance, the base station can grant an uplink transmission to the UE (e.g., via DCI). Based on the grant, the UE uses the resource blocks to transmit data to the network (e.g., following modulation, layer mapping, precoding, RF mapping, etc.). The base station receives the data.

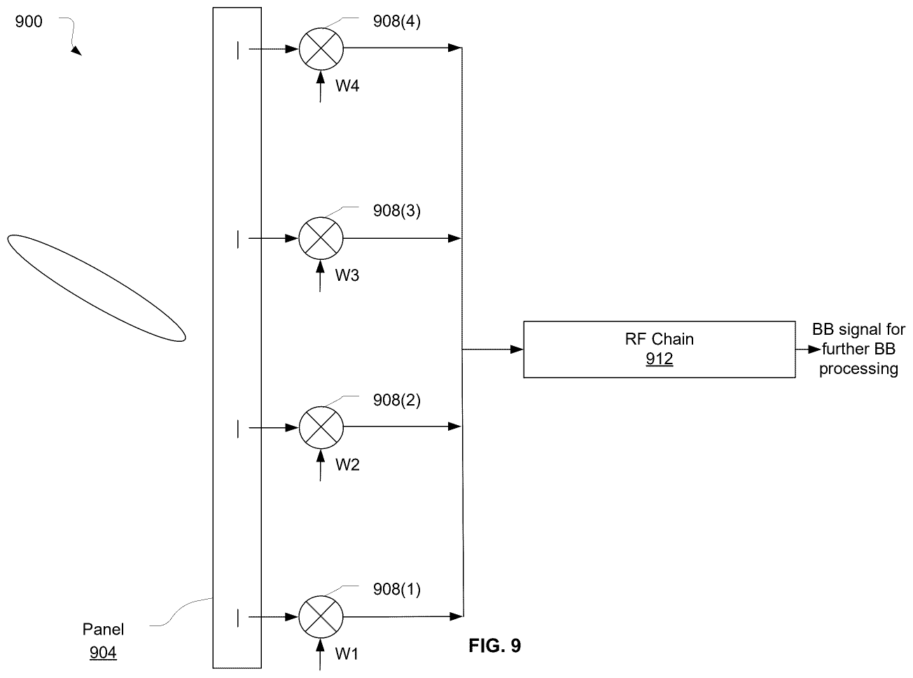

FIG. 9 illustrates receive components 900 of the UE 104, in accordance with some embodiments. The receive components 900 may include an antenna panel 904 that includes a number of antenna elements. The panel 904 is shown with four antenna elements, but other embodiments may include other numbers.

The antenna panel 904 may be coupled to analog beamforming (BF) components that include a number of phase shifters 908(1)-908(4). The phase shifters 908(1)-908(4) may be coupled with a radio-frequency (RF) chain 912. The RF chain 912 may amplify a receive analog RF signal, downconvert the RF signal to baseband, and convert the analog baseband signal to a digital baseband signal that may be provided to a baseband processor for further processing.

In various embodiments, control circuitry, which may reside in a baseband processor, may provide BF weights (for example W1-W4), which may represent phase shift values, to the phase shifters 908(1)-908(4) to provide a receive beam at the antenna panel 904. These BF weights may be determined based on the channel-based beamforming.

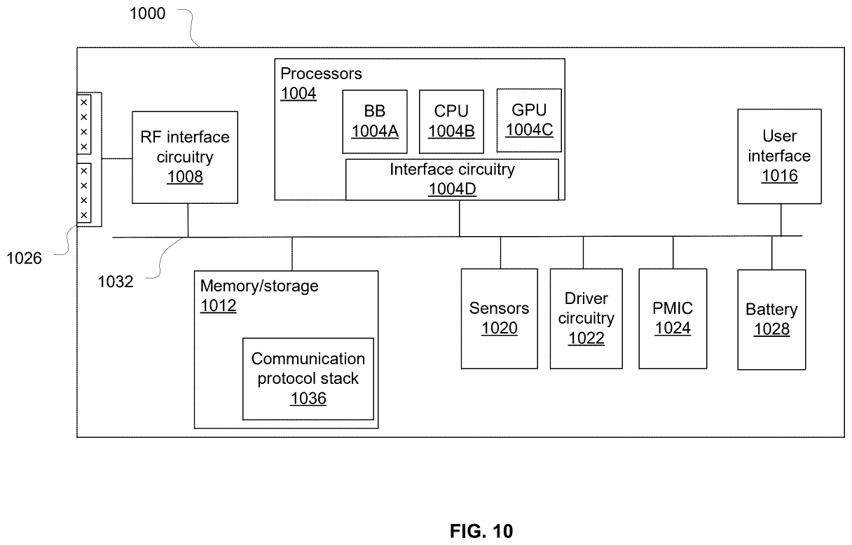

FIG. 10 illustrates a UE 1000, in accordance with some embodiments. The UE 1000 may be similar to and substantially interchangeable with UE 104 of FIG. 1. Particularly, the UE 1000 can include a full-band duplexer. It may be possible that the UE 1000 implements particular circuitry to meet emission requirements for a frequency band without necessitating resource block restrictions for the frequency band and without needing to use A-MPR. Alternatively, the UE 1000 may need to rely on resource block restrictions for the frequency band to meet the emission requirements without needing to use A-MPR. As such, the UE 1000 can signal to the network whether meeting the emission requirements for the frequency band may necessitate resource block restrictions or not.

Similar to that described above with respect to UE 104, the UE 1000 may be any mobile or non-mobile computing device, such as mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, actuators, etc.), video surveillance/monitoring devices (for example, cameras, video cameras, etc.), wearable devices, or relaxed-IoT devices. In some embodiments, the UE may be a reduced capacity UE or NR-Light UE.

The UE 1000 may include processors 1004, RF interface circuitry 1008, memory/storage 1012, user interface 1016, sensors 1020, driver circuitry 1022, power management integrated circuit (PMIC) 1024, and battery 1028. The components of the UE 1000 may be implemented as integrated circuits (ICs), portions thereof, discrete electronic devices, or other modules, logic, hardware, software, firmware, or a combination thereof. The block diagram of FIG. 10 is intended to show a high-level view of some of the components of the UE 1000. However, some of the components shown may be omitted, additional components may be present, and different arrangements of the components shown may occur in other implementations.

The components of the UE 1000 may be coupled with various other components over one or more interconnects 1032, which may represent any type of interface, input/output, bus (local, system, or expansion), transmission line, trace, optical connection, etc. that allows various circuit components (on common or different chips or chipsets) to interact with one another.

The processors 1004 may include processor circuitry, such as baseband processor circuitry (BB) 1004A, central processor unit circuitry (CPU) 1004B, and graphics processor unit circuitry (GPU) 1004C. The processors 1004 may include any type of circuitry or processor circuitry that executes or otherwise operates computer-executable instructions, such as program code, software modules, or functional processes from memory/storage 1012 to cause the UE 1000 to perform operations as described herein.

In some embodiments, the baseband processor circuitry 1004A may access a communication protocol stack 1036 in the memory/storage 1012 to communicate over a 3GPP compatible network. In general, the baseband processor circuitry 1004A may access the communication protocol stack to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a non-access stratum “NAS” layer. In some embodiments, the PHY layer operations may additionally/alternatively be performed by the components of the RF interface circuitry 1008.

The baseband processor circuitry 1004A may generate or process baseband signals or waveforms that carry information in 3GPP-compatible networks. In some embodiments, the waveforms for NR may be based on cyclic prefix OFDM (CP-OFDM) in the uplink or downlink, and discrete Fourier transform spread OFDM (DFT-S-OFDM) in the uplink.

The baseband processor circuitry 1004A may also access group information from memory/storage 1012 to determine search space groups in which a number of repetitions of a PDCCH may be transmitted.

The memory/storage 1012 may include any type of volatile or non-volatile memory that may be distributed throughout the UE 1000. In some embodiments, some of the memory/storage 1012 may be located on the processors 1004 themselves (for example, L1 and L2 cache), while other memory/storage 1012 is external to the processors 1004 but accessible thereto via a memory interface. The memory/storage 1012 may include any suitable volatile or non-volatile memory, such as, but not limited to, dynamic random-access memory (DRAM), static random-access memory (SRAM), erasable programmable read-only memory (EPROM), electrically erasable programmable read-only memory (EEPROM), Flash memory, solid-state memory, or any other type of memory device technology.

The RF interface circuitry 1008 may include transceiver circuitry and a radio frequency front module (RFEM) that allows the UE 1000 to communicate with other devices over a radio access network. The RF interface circuitry 1008 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via an antenna 1050 and proceed to filter and amplify (with a low-noise amplifier) the signal. The signal may be provided to a receiver of the transceiver that down-converts the RF signal into a baseband signal that is provided to the baseband processor of the processors 1004.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 1050.

In various embodiments, the RF interface circuitry 1008 may be configured to transmit/receive signals in a manner compatible with NR access technologies.

The antenna 1050 may include a number of antenna elements that each convert electrical signals into radio waves to travel through the air and to convert received radio waves into electrical signals. The antenna elements may be arranged into one or more antenna panels. The antenna 1050 may have antenna panels that are omnidirectional, directional, or a combination thereof to enable beamforming and multiple input, multiple output communications. The antenna 1050 may include microstrip antennas, printed antennas fabricated on the surface of one or more printed circuit boards, patch antennas, phased array antennas, etc. The antenna 1050 may have one or more panels designed for specific frequency bands including bands in FR1 or FR2.

The user interface circuitry 1016 includes various input/output (I/O) devices designed to enable user interaction with the UE 1000. The user interface 1016 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators, such as light emitting diodes (LEDs) and multi-character visual outputs, or more complex outputs, such as display devices or touchscreens (for example, liquid crystal displays (LCDs), LED displays, quantum dot displays, projectors, etc.), with the output of characters, graphics, multimedia objects, and the like being generated or produced from the operation of the UE 1000.

The sensors 1020 may include devices, modules, or subsystems whose purpose is to detect events or changes in its environment and send the information (sensor data) about the detected events to some other device, module, subsystem, etc. Examples of such sensors include, inter alia, inertia measurement units comprising accelerometers; gyroscopes; or magnetometers; microelectromechanical systems or nanoelectromechanical systems comprising 3-axis accelerometers; 3-axis gyroscopes; or magnetometers; level sensors; flow sensors; temperature sensors (for example, thermistors); pressure sensors; barometric pressure sensors; gravimeters; altimeters; image capture devices (for example; cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 1022 may include software and hardware elements that operate to control particular devices that are embedded in the UE 1000, attached to the UE 1000, or otherwise communicatively coupled with the UE 1000. The driver circuitry 1022 may include individual drivers allowing other components to interact with or control various input/output (I/O) devices that may be present within, or connected to, the UE 1000. For example, driver circuitry 1022 may include a display driver to control and allow access to a display device, a touchscreen driver to control and allow access to a touchscreen interface, sensor drivers to obtain sensor readings of sensor circuitry 1020 and control and allow access to sensor circuitry 1020, drivers to obtain actuator positions of electro-mechanic components or control and allow access to the electro-mechanic components, a camera driver to control and allow access to an embedded image capture device, audio drivers to control and allow access to one or more audio devices.

The PMIC 1024 may manage power provided to various components of the UE 1000. In particular, with respect to the processors 1004, the PMIC 1024 may control power-source selection, voltage scaling, battery charging, or DC-to-DC conversion.

In some embodiments, the PMIC 1024 may control, or otherwise be part of, various power saving mechanisms of the UE 1000. For example, if the platform UE is in an RRC_Connected state, where it is still connected to the RAN node as it expects to receive traffic shortly, then it may enter a state known as Discontinuous Reception Mode (DRX) after a period of inactivity. During this state, the UE 1000 may power down for brief intervals of time and thus save power. If there is no data traffic activity for an extended period of time, then the UE 1000 may transition off to an RRC_Idle state, where it disconnects from the network and does not perform operations, such as channel quality feedback, handover, etc. The UE 1000 goes into a very low power state and it performs paging where again it periodically wakes up to listen to the network and then powers down again. The UE 1000 may not receive data in this state; in order to receive data, it must transition back to RRC_Connected state. An additional power saving mode may allow a device to be unavailable to the network for periods longer than a paging interval (ranging from seconds to a few hours). During this time, the device is totally unreachable to the network and may power down completely. Any data sent during this time incurs a large delay and it is assumed the delay is acceptable.

A battery 1028 may power the UE 1000, although in some examples the UE 1000 may be mounted deployed in a fixed location and may have a power supply coupled to an electrical grid. The battery 1028 may be a lithium-ion battery, a metal-air battery, such as a zinc-air battery, an aluminum-air battery, a lithium-air battery, and the like. In some implementations, such as in vehicle-based applications, the battery 1028 may be a typical lead-acid automotive battery.

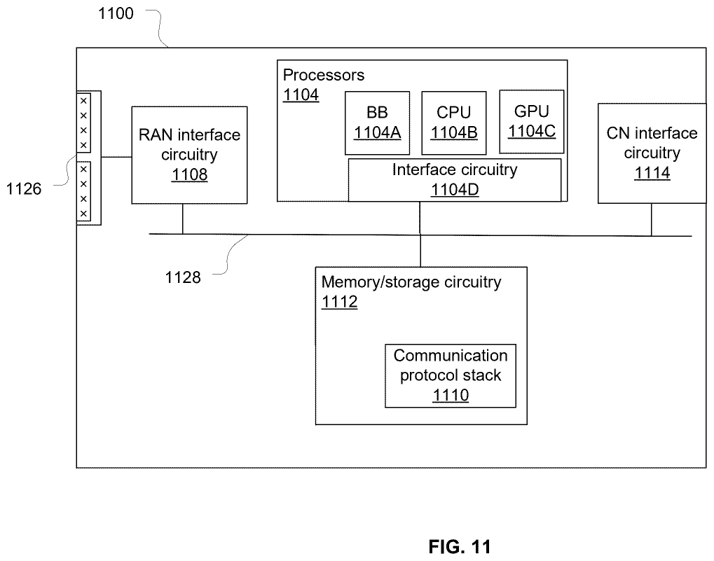

FIG. 11 illustrates a gNB 1100, in accordance with some embodiments. The gNB 1100 may be similar to and substantially interchangeable with the gNB 108 of FIG. 1. Particularly, the gNB 1100 can be a component of a network that provides many frequency bands for communications with a UE. Among such frequency bands, a particular frequency band (e.g., n28) can be adjacent to a protected frequency band (e.g., that of another network or used for other services). The gNB 1100 can signal to the UE an NS value associated with emission requirements for the frequency band, can receive signaling of the UE indicating whether a resource block restriction is needed to meet the emission requirements, and may configure resource blocks of a channel within the frequency band based on the signaling of the UE.

The gNB 1100 may include processors 1104, RAN interface circuitry 1108, core network (CN) interface circuitry 1112, and memory/storage circuitry 1116.

The components of the gNB 1100 may be coupled with various other components over one or more interconnects 1128.

The processors 1104, RAN interface circuitry 1108, memory/storage circuitry 1116 (including communication protocol stack 1110), antenna 1150, and interconnects 1128 may be similar to like-named elements shown and described with respect to FIG. 10.

The CN interface circuitry 1112 may provide connectivity to a core network, for example, a Fifth Generation Core network (5GC) using a 5GC-compatible network interface protocol, such as carrier Ethernet protocols, or some other suitable protocol. Network connectivity may be provided to/from the gNB 1100 via a fiber optic or wireless backhaul. The CN interface circuitry 1112 may include one or more dedicated processors or FPGAs to communicate using one or more of the aforementioned protocols. In some implementations, the CN interface circuitry 1112 may include multiple controllers to provide connectivity to other networks using the same or different protocols.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### EXAMPLES

In the following sections, further exemplary embodiments are provided.

Example 1 includes a method comprising: processing first signaling of a network indicating an emission requirement with which a user equipment (UE) is to comply for a frequency band; sending, to the network, second signaling indicating whether a resource block restriction within the frequency band is needed to meet the emission requirement; determining, after the second signaling is sent, an allocation of a resource block within the frequency band; and sending, to the network, uplink traffic by at least using the resource block.

Example 2 includes a method comprising: sending, to a user equipment (UE), first signaling indicating an emission requirement with which the UE is to comply for a frequency band; receiving, from the UE, second signaling indicating whether a resource block restriction within the frequency band is needed to meet the emission requirement; sending, after the second signaling is received, third signaling to the UE indicating an allocation of a resource block within the frequency band; and receiving, from the UE, uplink traffic that least uses the resource block.

Example 3 includes a method comprising: processing first signaling of a network indicating an emission requirement with which a user equipment (UE) is to comply for a frequency band; sending, to the network via the transmitter, second signaling indicating whether a resource block restriction within the frequency band is needed to meet the emission requirement; determining, after the second signaling is sent, an allocation of a resource block within the frequency band; and sending, to the network via the transmitter, uplink traffic by at least using the resource block.

Example 4 includes the method of any example 1-3, wherein a power class of the UE is associated with a maximum power reduction (MPR), and wherein the emission requirement is met without an additional maximum power reduction (A-MPR).

Example 5 includes the method of example 4, wherein the first signaling indicates that the frequency band is frequency band number twenty-eight (n28), wherein the power class is a power class two (PC2) or a power class three (PC3), and wherein the uplink traffic is transmitted from the UE to the network by using at least a full-band duplexer of the UE.

Example 6 includes the method of any example 1-5, wherein the second signaling includes an indication of a modified maximum power reduction (MPR) behavior.

Example 7 includes the method of example 6, wherein the indication includes a field, wherein one or more bits of the field are set to indicate whether the resource block restriction is needed to meet the emission requirement.

Example 8 includes the method of example 7, wherein the one or more bits are set to a value indicating that the emission requirement is met without resource block restriction.

Example 9 includes the method of example 8, wherein the allocation of the resource block is unrestricted within the frequency band based on the value of the one or more bits.

Example 10 includes the method of example 7, wherein the one or more bits are set to a value indicating that the resource block restriction is needed to meet emission requirement.

Example 11 includes the method of example 10, wherein the allocation of the resource block is restricted within the frequency band based on the value of the one or more bits.

Example 12 includes the method of example 10, wherein a power class of the UE is associated with a maximum power reduction (MPR), wherein the allocation of the resource block is unrestricted within the frequency band, and wherein the uplink traffic is transmitted from the UE to the network without an additional maximum power reduction (A-MPR).

Example 13 includes the method of any example 1-12, wherein the resource block restriction is associated with a contiguous set of resource blocks that can be allocated within the frequency band.

Example 14 includes the method of any example 1-13, wherein the resource block restriction is associated with a set of resource blocks that can be allocated within the frequency band and that can be configured for the UE based on corresponding subcarrier frequencies.

Example 15 includes the method of any example 1-13, wherein the resource block restriction is associated with a set of resource blocks that can be allocated within the frequency band and that can be configured for the UE based on a channel within the frequency band.

Example 16 includes the method of any example 1-5, wherein the second signaling indicates that the emission requirement is met without the resource block restriction, and wherein the allocation of the resource block is unrestricted within the frequency band based on the second signaling.

Example 17 includes the method of any example 1-15, wherein the second signaling indicates that the resource block restriction is needed to meet emission requirement.

Example 18 includes the method of any example 1-16, wherein the allocation of the resource block is restricted within the frequency band based on the second signaling.

Example 19 includes the method of any example 1-16, wherein a power class of the UE is associated with a maximum power reduction (MPR), wherein the allocation of the resource block is unrestricted within the frequency band, and wherein the uplink traffic is received without an additional maximum power reduction (A-MPR).

Example 20 includes the method of any example 1-19, wherein the second signaling includes an indication of a modified maximum power reduction (MPR) behavior, wherein the indication includes a field, wherein one or more bits of the field are set to indicate whether the resource block restriction is needed to meet the emission requirement.

Example 21 includes a user equipment (UE) or an apparatus comprising: one or more processors; and one or more memory storing instructions that, upon execution by the one or more processors, configure the UE or the apparatus to perform a method described in or related to any of the preceding examples.

Example 22 includes one or more computer-readable media storing instructions that, when executed on a user equipment (UE) or an apparatus, cause the UE or the apparatus to perform operations comprising one or more elements of a method described in or related to any of the preceding examples.

Example 23 includes an apparatus comprising means to perform one or more elements of a method described in or related to any of the preceding examples.

Example 24 includes one or more non-transitory computer-readable media comprising instructions to cause an apparatus, upon execution of the instructions by one or more processors of the apparatus, to perform one or more elements of a method described in or related to any of the preceding examples.

Example 25 includes an apparatus comprising logic, modules, or processing circuitry configured to perform one or more elements of a method described in or related to any of the preceding examples.

Example 26 includes an apparatus, a network, a base station, or a system comprising: one or more processors and one or more computer-readable media comprising instructions that, when executed by the one or more processors, cause the one or more processors to perform one or more elements of a method described in or related to any of the preceding examples.

Any of the above-described examples may be combined with any other example (or combination of examples), unless explicitly stated otherwise. The foregoing description of one or more implementations provides illustration and description but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

1. A method comprising:
processing first signaling of a network indicating an emission requirement with which a user equipment (UE) is to comply for a frequency band;
sending, to the network, second signaling indicating whether a resource block restriction within the frequency band is needed to meet the emission requirement;
determining, after the second signaling is sent, an allocation of a resource block within the frequency band; and
sending, to the network, uplink traffic by at least using the resource block.

2. The method of claim 1, wherein a power class of the UE is associated with a maximum power reduction (MPR), and wherein the emission requirement is met without an additional maximum power reduction (A-MPR).

3. The method of claim 2, wherein the first signaling indicates that the frequency band is frequency band number twenty-eight (n28), wherein the power class is a power class two (PC2) or a power class three (PC3), and wherein the uplink traffic is transmitted from the UE to the network by using at least a full-band duplexer of the UE.

4. The method of claim 1, wherein the second signaling includes an indication of a modified maximum power reduction (MPR) behavior.

5. The method of claim 4, wherein the indication includes a field, wherein one or more bits of the field are set to indicate whether the resource block restriction is needed to meet the emission requirement.

6. The method of claim 5, wherein the one or more bits are set to a value indicating that the emission requirement is met without resource block restriction.

7. The method of claim 6, wherein the allocation of the resource block is unrestricted within the frequency band based on the value of the one or more bits.

8. The method of claim 5, wherein the one or more bits are set to a value indicating that the resource block restriction is needed to meet emission requirement.

9. The method of claim 8, wherein the allocation of the resource block is restricted within the frequency band based on the value of the one or more bits.

10. The method of claim 8, wherein a power class of the UE is associated with a maximum power reduction (MPR), wherein the allocation of the resource block is unrestricted within the frequency band, and wherein the uplink traffic is transmitted from the UE to the network without an additional maximum power reduction (A-MPR).

11. The method of claim 1, wherein the resource block restriction is associated with a contiguous set of resource blocks that can be allocated within the frequency band.

12. The method of claim 1, wherein the resource block restriction is associated with a set of resource blocks that can be allocated within the frequency band and that can be configured for the UE based on corresponding subcarrier frequencies.

13. The method of claim 1, wherein the resource block restriction is associated with a set of resource blocks that can be allocated within the frequency band and that can be configured for the UE based on a channel within the frequency band.

14. A method comprising:
sending, to a user equipment (UE), first signaling indicating an emission requirement with which the UE is to comply for a frequency band;
receiving, from the UE, second signaling indicating whether a resource block restriction within the frequency band is needed to meet the emission requirement;
sending, after the second signaling is received, third signaling to the UE indicating an allocation of a resource block within the frequency band; and
receiving, from the UE, uplink traffic that least uses the resource block.

15. The method of claim 14, wherein the second signaling indicates that the emission requirement is met without the resource block restriction, and wherein the allocation of the resource block is unrestricted within the frequency band based on the second signaling.

16. The method of claim 14, wherein the second signaling indicates that the resource block restriction is needed to meet emission requirement.

17. The method of claim 16, wherein the allocation of the resource block is restricted within the frequency band based on the second signaling.

18. The method of claim 16, wherein a power class of the UE is associated with a maximum power reduction (MPR), wherein the allocation of the resource block is unrestricted within the frequency band, and wherein the uplink traffic is received without an additional maximum power reduction (A-MPR).

19. An apparatus comprising:
processing circuitry configured to be communicatively coupled with a transmitter and to perform operations comprising:
processing first signaling of a network indicating an emission requirement with which a user equipment (UE) is to comply for a frequency band;
sending, to the network via the transmitter, second signaling indicating whether a resource block restriction within the frequency band is needed to meet the emission requirement;
determining, after the second signaling is sent, an allocation of a resource block within the frequency band; and
sending, to the network via the transmitter, uplink traffic by at least using the resource block.

20. The apparatus of claim 19. wherein the second signaling includes an indication of a modified maximum power reduction (MPR) behavior, wherein the indication includes a field. wherein one or more bits of the field are set to indicate whether the resource block restriction is needed to meet the emission requirement.
